(19) United States
(12) Patent Application Publication
(10) Pub. No.: US 2009/0084105 A1
(43) Pub. Date: Apr. 2, 2009

(54) Machine to convert gravity to mechanical energy

(76) Inventor: Brian Peter Sandler, West Bloomfield, MI (US)

Correspondence Address: Brian P. Sandler, 5643 Putnam, West Bloomfield, MI, 48323, US

(21) Appl. No.: 11/906,464

(22) Filed: Oct. 2, 2007

(51) Int. Cl. F03B 17/00; F03B 17/04

(52) U.S. Cl. 60/495; 74/DIG. 9

(57) ABSTRACT

A empty tank submersed in a body of liquid will float to the surface, as the tank floats up it will do work. It is the goal of this machine to empty the tank after the tank has been submersed, and in the process of empting the tank do less work than the empty tank does when it floats up.

### BACKGROUND OF THE INVENTION

### FIELD OF INVENTION (MACHINE #1)

The present invention relates to energy production, more particularly converting gravity to mechanical energy.

### BRIEF SUMMARY OF THE INVENTION (MACHINE #1)

A empty tank submersed in a body of liquid will float to the surface, as. the tank floats up it will do work. It is the goal of this machine to empty the tank after the tank has been submersed, and in the process of empting the tank do less work than the empty tank does when it floats up.

A tank full of liquid will sink. Assuming the tank itself is heaver than liquid. As the tank full of liquid sinks, both the tank and the liquid in the tank accelerate do to the force of gravity. As the tank and the liquid in the tank accelerate they both build momentum.

The momentum of the liquid and part of the tank is the force this machine uses to empty the tank.

The machine is long and narrow, shaped somewhat like a arrow. The machine is expandable. The machine has piston-like tanks full of liquid. The piston-like tanks are inside other tanks.

As the machine falls thru the liquid it builds-up speed, than the top part of the machine is abruptly stopped, the piston-like tanks full of heavy liquid keep going, pulling themselves out of the tanks there in, expanding the machine, as the machine expands its buoyancy increases and the machine floats up

### BRIEF DESCRIPTION OF THE DRAWINGS (MACHINE #1)

FIG. 1 is a side view of the machine in its un-expanded position

FIG. 2 is a side view of the machine in its expanded position

FIG. 3 is a top view looking down at the machine.

FIG. 4 is a flow chart for the machine.

Number 1. is a hole in the piston shaft, #1 allows gas to travel from tank 2a to tank 2c and from tank 2d to tank 2b,

Number 2a. is a tank with somewhat compressed gas in it and a piston-like tank full of liquid (3a) is also in it.

Number 2c. Is the lower tank with a piston-like tank full of liquid (3a) in it.

Number 2b is the same tank as 2a except the piston-like tank full of liquid (3b) has moved out of it.

Number 2d is the same tank as 2c except the piston-like tank full of liquid (3b) has moved out of it.

Number 3a. is the piston-like tank full of liquid in the un-expanded position.

Number 3b is the piston-like tank full of liquid in the expanded position.

Number 4 is the nose-cone full of liquid.

Number 5 is a retractable stop.

Number 6. is a large tank full of liquid

Number 7 is liquid.

Number 8 is the starting position for the machine.

Number 9 is the position where the machine abruptly stops.

Number 10 is the bottom stop.

Number 11 is where the machine attaches to the load.

Number 12 is where the machine detaches from the load.

Number 13 is where the machine abruptly stops again.

Number 14 is the upper stop.

Number 15 is the load.

Number 16 is a piston lock for the extended position.

Number 17 is a piston lock for the un-extended position

### DETAILED DESCRIPTION OF THE INVENTION (MACHINE #1)

A empty tank submersed in a body of liquid will float to the surface, as the tank floats up it will do work. It is the goal of this machine to empty the tank after the tank has been submersed, and in the process of empting the tank do less work than the empty tank does when it floats up.

A tank full of liquid will sink, assuming the tank itself is heaver than the liquid. As the tank full of liquid sinks both the tank and the liquid in the tank accelerate do to the force of gravity. As the tank and the liquid in the tank accelerate they both build momentum. The momentum of the liquid and part of the tank are the forces used to expand the machine.

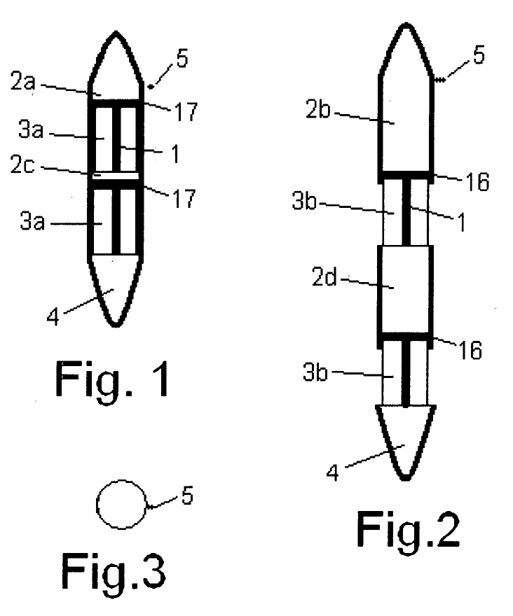

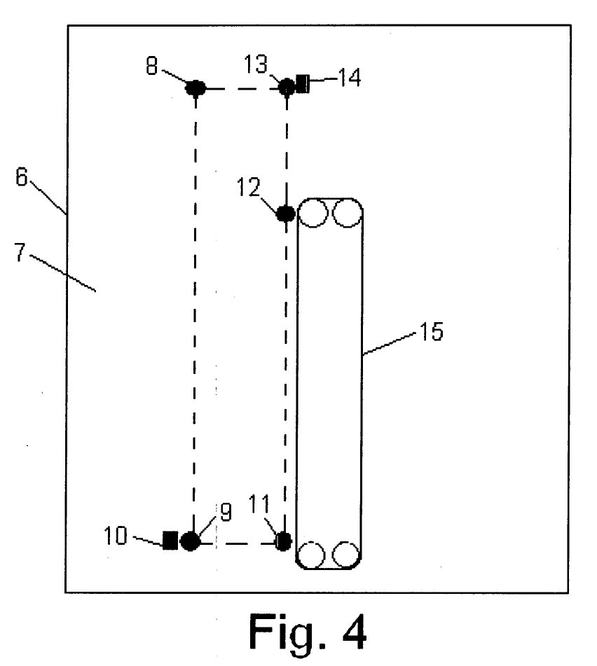

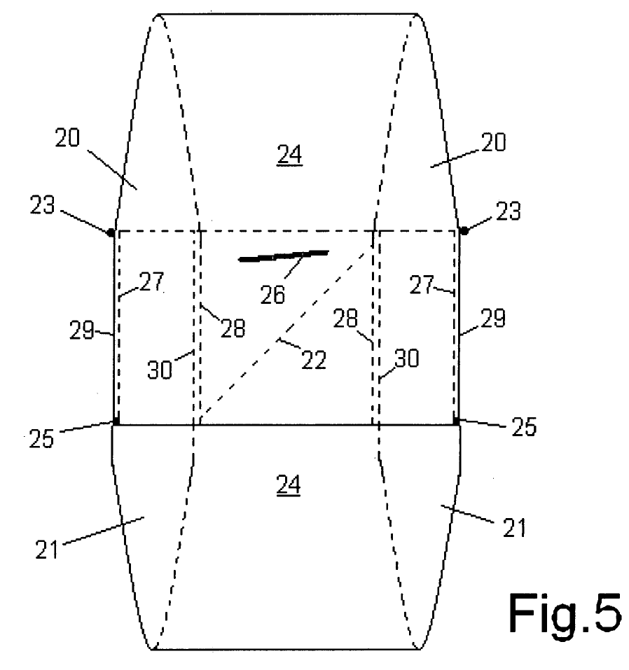

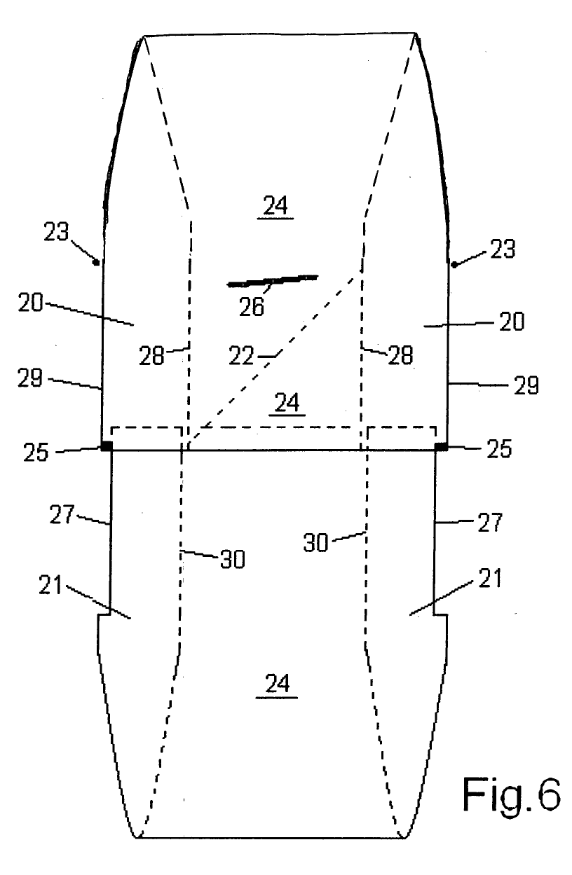

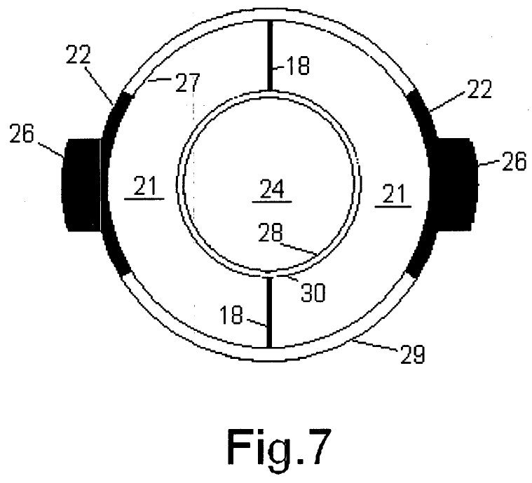

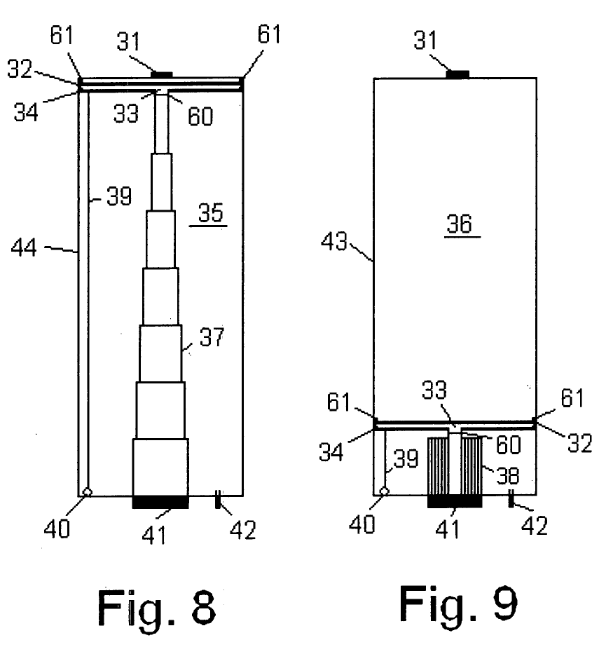

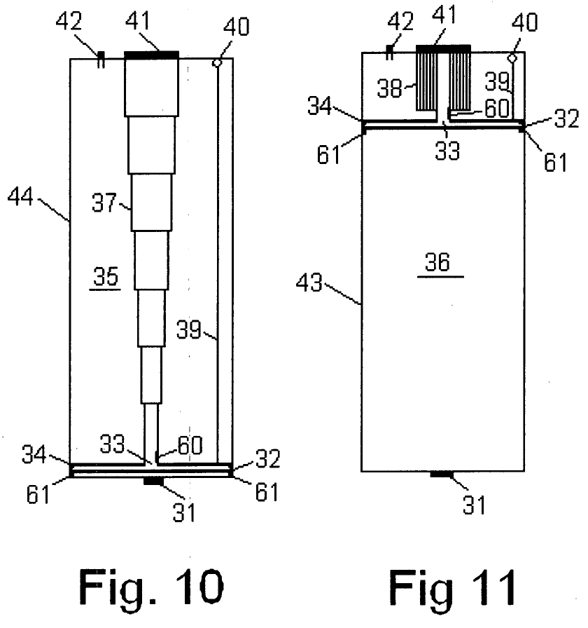

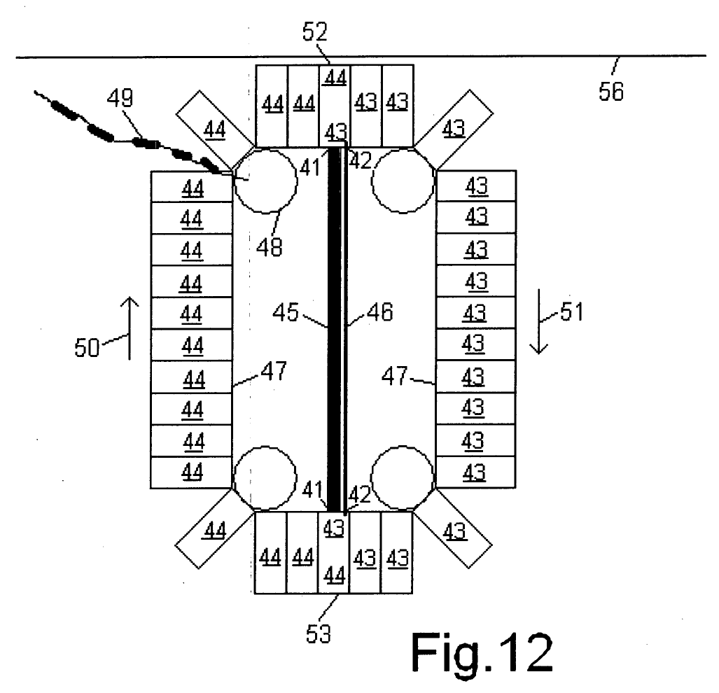

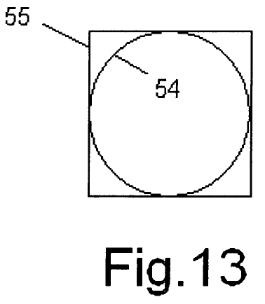

The un-expanded machine (FIG. 1) starts its cycle at position #8 in FIG. 4. The un-expanded machine free-falls thru the liquid (7) in the large tank (6) as the machine falls thru the liquid the piston-like tanks full of liquid (3a) and the nose-cone full of liquid (4) build momentum until it gets to position #9. At position #9 the top part of the un-expanded machine is abruptly stopped by the bottom stop (10) in the tank, and retractable stop (5) on the un-expanded machine.

When the top part of the un-expanded machine is abruptly stopped it becomes a expanded machine (FIG. 2). The momentum of the piston-like tanks full of liquid (3a) and the nose-cone full of liquid (4) pulls the piston-like tanks full of liquid (3a) out of tanks 2a and 2c. Expanding the machine. Tank 2a turns into tank 2b. And tank 2c turns into tank 2d. The gas pressure in tanks 2b and 2d is lowered. The gas pressure is equalized between tank 2b and 2d by the hole in the piston shaft (1). The piston-like tanks full of liquid in the expanded position (3b) are than locked into position by the piston locks (16). The expanded machine should now be lighter than the liquid it displaces.

Next the machine is transferred from the #9 position to the #11 position. At the #11 position the machine is attached to a load (15). Next the . . . . machine floats up to the #12 position doing work between the 11^{th}and 12^{th} position. At the position #12 the machine is detached from the load (15) and aloud to float up, accelerating freely until it gets to the #13 position. At the #13 position the top part of the machine is again abruptly stopped by the upper stop (14) and the retractable stop (5) The low gas pressure in tanks 2b and 2d combined with the momentum of the piston-like tanks full of liquid (3b) and the nose-cone (4) force the pistons (3b) up into tank 2a and 2c, the machine becomes un-expanded. The piston locks (17) lock the pistons in the un-expanded position.

At that point the weight of the machine is greater than the weight of the displaced liquid and the machine will sink. The machine is than transferred from position #13 to Position #8 completing the cycle.

The same liquid should be used in tanks 3a, 3b, 6 and the nose-cone (4)

The energy added to the system comes from the momentum of the falling and rising machine and the position of the expanded and un-expanded machine.

### CLAIMS MACHINE #1

I claim:

1. A machine to convert gravity to mechanical energy, comprising:
a) a machine in a un-expanded position (FIG. 1)
b) a machine in a expanded position (FIG. 2)
c) a hole in the piston shaft (1)
d) a tank with somewhat compressed gas and a piston-like tank full of liquid in it (2a)
e) a tank with lowered gas pressure and the piston-like tank full of liquid moved out of it (2b)
f) a tank with somewhat compressed gas and a piston-like tank full of liquid in it (2c)
g) a tank with a piston-like tank full of liquid moved out of it and lowered gas pressure (2d)
h) a piston-like tank full of liquid in the un-expanded position (3a)
I) a piston-like full of liquid in the expanded position (3b)
j) a nose-cone full of liquid (4)
k) a retractable stop (5)
l) a piston lock for the extended piston (16)
m) a piston lock for the un-extended piston (17).

2. A process to convert gravity to mechanical energy, comprising:
step 1 is submersing a tank full of liquid,
step 2 is removing the liquid from the submerged tank,
step 3 is attaching the empty tank to a load,
step 4 is floating the empty tank up doing work.

### BACKGROUND OF THE INVENTION

### Field of the Invention (MACHINE #2)

The present invention relates to energy production, more particularly converting gravity to mechanical energy.

### BRIEF SUMMARY OF THE INVENTION (MACHINE #2)

A empty tank submersed in a body of liquid will float to the surface, as the tank floats up it will do work. It is the goal of this machine to empty the tank after the tank has been submersed, and in the process of empting the tank do less work than the empty tank does when it floats up.

A tank full of liquid will sink, assuming the tank itself is heaver than the liquid. As the tank full of liquid sinks both the tank and the liquid in the tank accelerate do to the force of gravity. As the tank and the liquid in the tank accelerate they both build momentum. The combined momentum of the liquid in the tank and the tank itself is the force this machine uses to empty the tank.

A body falling thru a liquid will build linear momentum in the downward direction, if the body spins as it falls it will also build angular momentum. This machine uses the combination of linear momentum and angular momentum to empty the tank.

### BRIEF DESCRIPTION OF THE DRAWINGS (MACHINE#2)

FIG. 4 is a flow chart (machine #1 and machine #2 both use the same flow chart).

FIG. 5 is a side view of machine #2 in a un-expanded position

FIG. 6 is a side view of machine #2 in a expanded position.

FIG. 7 is a top view looking down of machine #2

Number 6 is a large tank full of liquid.

Number 7 is liquid.

Number 8 is the starting position for the machine.

Number 9 is the position where the machine abruptly stops.

Number 10 is the bottom stop.

Number 11 is where the machine attaches to the load.

Number 12 is where the machine detaches from the load.

Number 13 is where the machine abruptly stops again.

Number 14 is the upper stop.

Number 15 is the load.

Number 18 are tank dividers.

Number 20 is a tank in the upper part of the machine.

Number 21 is a tank in the lower part of the machine.

Number 22 are screw threads.

Number 23 are stops.

Number 24 is the hollow center of the machine.

Number 25 are locks

Number 26 are the wings that make the machine spin.

Number 27 is the outer wall of tank number 21.

Number 28 is the inner wall of tank number 20.

Number 29 is the outer wall of tank number 20.

Number 30 is the inner wall of tank number 21.

### DETAILED DESCRIPTION OF THE INVENTION (MACHINE #2)

The machine has two main parts, the upper tank (20) and the lower tank (21). The upper tank (20) contains gas, the lower tank (21) contains liquid.

The machine is expandable, FIG. 5 is the machine in the un-expanded position, FIG. 6 is the machine in the expanded position. The way the machine expands is the lower and upper tanks unscrew from each other. Number 18 are tank dividers, Number 22s are screw threads. Number 23s are stops. Number 24 is the hollow center of the machine. Number 26s are the wings that make the machine spin as it falls.

The machine starts the cycle at position #8 in FIG. 4. The machine free-falls thru the liquid (7) in the large tank (6) As the machine accelerates in the downward direction it also spins. The protruding wings (26) are angled slightly to make the machine spin. The tank dividers (18) keep the liquid in the lower tank (21) spinning at the same speed as the tank they are in. The machine builds both linear momentum in the downward direction and angular momentum.

The machine free-falls from position 8 to position 9. At position 9 the gas filled tank (20) in the upper part of the machine is abruptly stopped from spinning and falling by the stop in the tank (10) and by the stops on the machine (23). The lower tank (21) filled with heavy liquid keeps spinning and falling. The lower tank (21) unscrews from the upper tank (20) expanding the machine. The lower tank is locked in the expanded position by the locks (25).The machine changes from the un-expanded position in FIG. 5 to the expanded position in FIG. 6. The buoyancy of the machine increases, the weight of the liquid the machine displaces increases, the machine should now float. As the machine expands the gas pressure in the upper tank (20) decreases.

Next the machine is transferred from the #9 position to the #11 position. At the #11 position the machine is attached to a load (15) The machine . . . floats up to the #12 position. The machine does work between the 11^{th}and 12^{th} position. At position #12 the machine is detached from the load (15) and aloud to freely accelerate up, building both linear momentum in the up direction and angular momentum. At position #13 the upper part of the machine (20) is abruptly stopped by the upper stop in the tank (14) and the stops on the machine (23). The combination of the low pressure in the upper tank (20) and the linear and angular momentum of the liquid filled lower tank (21) causes the lower tank (21) to screw up into the upper tank (20). The machine is locked in the un-extended position by the locks (25). At this point the machine should be heaver than the liquid it displaces and will sink. At position #13 the machine goes from the expanded position FIG. 6 to the un-expanded position FIG. 5. The machine is than transferred from position #13 to position #8 and the cycle is complete.

### CLAIMS MACHINE #1

I claim:

1. A machine to convert gravity to mechanical energy, comprising:
a) a machine in the un-extended position, FIG. 5
b) a machine in the extended position FIG. 6
c) a machine with tank dividers, (18)
d) a tank containing gas. (20)
e) a tank containing liquid, (21)
f) a machine with screw threads, (22)
g) a machine with stops, (23)
h) a machine with a hollow center, (24)
I) a machine with locks, (25)
j) a machine with wings, (26).

2. A process to convert gravity to mechanical energy, comprising:
step 1 is submersing a tank full of liquid,
step 2 is removing the liquid from the submerged tank,
step 3 is attaching the empty tank to a load,
step 4 is floating the empty tank up doing work.

### BACKGROUND OF THE INVENTION

### Field of Invention (MACHINE #3)

The present invention relates to energy production, more particularly converting gravity to mechanical energy.

### BRIEF SUMMARY OF THE INVENTION (MACHINE #3)

A empty tank submersed in a body of liquid will float to the surface, as the tank floats up it will do work. It is the goal of this machine to empty the tank after the tank has been submersed, and in the process of empting the tank do less work than the empty tank does when it floats up.

This tank-car uses the weight of the liquid above it, and some of the work the empty tank-cars do as they float up to remove the liquid from the submerged tank-car.

### BRIEF DESCRIPTION OF THE DRAWINGS (MACHINE #3)

FIG. 8 is a side view of the tank-car with the telescoping hydraulic cylinder in the extended position.

FIG. 9 is a side view of the tank-car with the telescoping hydraulic cylinder in the un-extended position.

FIG. 10 is a side view of the tank-car with the telescoping hydraulic cylinder in the extended position.

FIG. 11 is a side view of the tank-car with the telescoping hydraulic cylinder in the un-extended position.

FIG. 12 is a flow chart for machine number 3.

FIG. 13 is a top view looking down on the tank-car.

Number 31 is a valve that lets the liquid (36) in and out of the tank-car.

Number 32 is a floating piston. The floating piston moves between the piston-like end of the telescoping hydraulic cylinder (34) and the stops (61)

Number 33 is the liquid inside of the telescoping hydraulic cylinder and pipe (45).

Number 34 is the piston-like end of the telescoping hydraulic cylinder.

Number 35 is the gas in the tank-car.

Number 36 is the liquid in the tank-car.

Number 37 is the telescoping hydraulic cylinder in the extended position.

Number 38 is the telescoping hydraulic cylinder in the un-extended position.

Number 39 is a cable that pulls the telescoping hydraulic cylinder and the piston (34) from a extended position to a un-extended position.

Number 40 is a wench that pulls the cable (39).

Number 41 is a connector and shut-off valve that lets liquid (33) in and out of the hydraulic telescoping cylinder. It is also where Number 45 attaches to the tank-car.

Number 42 is a connector and shut-off valve that lets gas in and out of the tank-car. It is also where Number 46 attaches to the tank-car.

Number 43 is the tank-car with the hydraulic telescoping cylinder in the un-extended position. (the tank-car is full of liquid)

Number 44 is the tank-car with the hydraulic telescoping cylinder in the extended position. (the tank-car is full of gas)

Number 45 is a pipe full of liquid (33).

Number 46 is a pipe full of gas (35).

Number 47 is a track that the tank-cars are attached to.

Number 48 is a generator.

Number 49 is a extension cord with floats.

Number 50 and 51 are arrows indicating the direction of movement for the tank-cars.

Number 52 is the position on the flow chart where the tank-car changes from number 44 to number 43.

Number 53 is the position on the flow chart where the tank-car changes . . . from number 43 to number 44.

Number 55 is the square outer wall of the tank-car.

Number 54 is the round inter wall of the tank-car.

Number 56 is a line indicating the top of the liquid.

Number 60 is a valve near the end of the hydraulic telescoping cylinder.

Number 61 is a stop.

### DETAILED DESCRIPTION OF THE INVENTION (MACHINE #3)

A empty tank submersed in a body of liquid will float to the surface, as the tank floats up it will do work. It is the goal of this machine to empty the tank after the tank has been submersed, and in the process of empting the tank do less work than the tank does when it floats up.

This tank-car uses the weight of the liquid above it, and some of the work the empty tank-cars do as they float up to remove the liquid from the submerged tank-car.

In FIG. 12 the empty tank-cars (44) are floating up, the tank-cars (43)full of liquid (36) are sinking, the process of the tank-cars floating and sinking causes the track (47) to move powering the generator (48) and the wench (40) The initial supply of gas (35) in the tank-cars (44) needs to be supplied by a external source.

At position 52 in FIG. 12 the tank-car changes from being full of gas (44) to being full of liquid(43), directly below it at position 53 another tank-car changes from being full of liquid (43) to being full of gas(44). The tank-car at position 52 than proceeds to sink, and the tank car at position 53 proceeds to float up doing work. The process of empting the tank-car of liquid and filling it with gas at position 53 (the bottom) and the process of removing the gas and filling the tank-car with liquid at position 52 (the top) is as follows.

At position 52 (the top) in FIG. 12 the tank-car gets there full of gas with the hydraulic telescoping cylinder in the extended position (44) The tank-car is than shifted off the moving track (47) and stops. From the other side of the track another tank-car that has already been processed moves in to replace it. At the same time at position 53 (the bottom) a tank-car gets there full of liquid (43) FIG. 11, that tank-car is than shifted off the moving track (47) and stopped. A tank-car that has already been processed moves in to replace it.

The tank-car (44) full of gas(35) at the top (position 52) now connects to the tank-car (43) full of liquid(36) at the bottom (position 53) via two pipes. One of the pipes contains liquid (33) the other contains gas (35). The pipe that contains liquid connects the hydraulic telescoping cylinder (37) of the top tank-car to the hydraulic telescoping cylinder(38) of the bottom tank-car, the connection is made at the connector and shut-off valve (41) for pipe that contains liquid (45). The pipe that contains gas (46) is connected at the connector and shut-off valve(42). The two pipes allow the free flow of liquid (33)and gas (35) between the tank-car at the top and the tank-car at the bottom. At this point the tank-car at the top looks like FIG. 8, the tank-car at the bottom looks like FIG. 11.

Next the valves 31,41,42 are opened on both the top and bottom tank-cars. Valve 60 is closed on the top tank-car and opened on the bottom tank-car. Liquid (36) starts to flow into the top tank-car thru valve Number 31. The wench (40) in the top tank-car starts. The wench (40) pulls the cable (39), the cable is attached to the piston at the end of the hydraulic telescoping cylinder(34). As the piston (34) in the top tank-car is pulled down, the hydraulic pressure inside the hydraulic telescoping cylinder(37) increases enough to force the un-expanded hydraulic cylinder (38) to expand, as it expands it forces the piston in the bottom tank-car down. As the piston in the bottom tank-car moves down it forces the liquid (36) in the tank-car out thru valve 31. Gas (35) from the top tank-car(44) flows thru line 46 to replace the liquid (36) being removed from the bottom tank-car(43). The hydraulic telescoping cylinder in the bottom tank-car becomes fully extended(37), and the hydraulic telescoping cylinder in the top tank-car becomes fully un-extended(38).

The tank-car in the Number 52 position (the top) should now look like FIG. 9, and the tank-car in the Number 53 position (the bottom) should now look like FIG. 10. The bottom tank-car is full of gas, and the top tank-car is full of liquid. At the top tank-car Number 44 turned into tank-car Number 43. At the bottom tank-car Number 43 turned into tank-car Number 44.

The processed tank-cars are than shifted back onto the track (47). The tank-car at the bottom (44) floats up doing work, the tank-car at the top (43) sinks.

The process is repeated on the next tank-cars in line.

The liquid (33), inside the hydraulic cylinder (37) (38)and the pipe (45) is separate from the other liquid (36).

FIG. 13 is a top view of the tank-car looking down. The inner part of the tank-car is a cylinder (54), the outer part of the tank-car (55) is a rectangle. The outer rectangular part of the tank-car reduces drag as the tank-car moves thru the liquid.

Number 49 is a extension cord with floats.

There is a continuous column of liquid from the piston in the bottom tank-car to the piston in the top tank-car, the pressure of the liquid in that column offsets the external pressure on the piston in the bottom tank-car.

Also when valve 60 in the top tank-car is closed all the weight of the liquid above it is transferred from the large surface area of the of the liquid (33) between the two top pistons to the smaller surface area of the liquid inside the extended hydraulic telescoping cylinder, increasing the pressure inside the hydraulic telescoping, cylinder.

At the bottom valve 60 is open allowing the high pressure of the liquid (33) to touch the large surface area of the piston (32), offsetting the high external pressure on the piston.

### CLAIMS MACHINE #3

I claim:

1. A machine to convert gravity to mechanical energy, comprising:
a) a tank-car with a hydraulic telescoping cylinder in the extended position, FIG. 8
b) a tank-car with a hydraulic telescoping cylinder in the un-extended position, FIG. 9
c) a valve in the tank-car (31),
d) a floating piston in the tank-car (32),
c) a piston-like end of a hydraulic telescoping cylinder (34) with stops (61),
d) a cable in the tank-car (39),
e) a wench in the tank-car (40),
f) a connector and shut-off valve (41) in the tank-car for the liquid (33),
g) a connector and shut-off valve (42) in the tank-car for the gas (35),
h) a pipe full of liquid (45),
I) a pipe full of gas (46),
j) a track that the tank-cars are attached to (47),
k) a generator (48),
l) a extension cord with floats (49),
m) a valve near the end of the hydraulic telescoping cylinder (60).

2. A process to convert gravity to mechanical energy, comprising:
step 1 is submersing a tank full of liquid,
step 2 is removing the liquid from the submerged tank,
step 3 is attaching the empty tank to a load,
step 4 is floating the empty tank up doing work.

I claim:

1. A machine to convert gravity to mechanical energy, comprising:
a) a machine in a un-expanded position (FIG. 1)
b) a machine in a expanded position (FIG. 2)
c) a hole in the piston shaft (1)
d) a tank with somewhat compressed gas and a piston-like tank full of liquid in it (2a)
e) a tank with lowered gas pressure and the piston-like tank full of liquid moved out of it (2b)
f) a tank with somewhat compressed gas and a piston-like tank full of liquid in it (2c)
g) a tank with a piston-like tank full of liquid moved out of it and lowered gas pressure (2d)
h) a piston-like tank full of liquid in the un-expanded position (3a)
I) a piston-like full of liquid in the expanded position (3b)
j) a nose-cone full of liquid (4)
k) a retractable stop (5)
l) a piston lock for the extended piston (16)
m) a piston lock for the un-extended piston (17).

2. A machine to convert gravity to mechanical energy, comprising:
a) a machine in the un-extended position, FIG. 5
b) a machine in the extended position FIG. 6
c) a machine with tank dividers, (18)
d) a tank containing gas. (20)
e) a tank containing liquid, (21)
f) a machine with screw threads, (22)
g) a machine with stops, (23)
h) a machine with a hollow center, (24)
I) a machine with locks, (25)
j) a machine with wings, (26).

3. A machine to convert gravity to mechanical energy, comprising:
a) a tank-car with a hydraulic telescoping cylinder in the extended position, FIG. 8
b) a tank-car with a hydraulic telescoping cylinder in the un-extended position, FIG. 9
c) a valve in the tank-car (31),
d) a floating piston in the tank-car (32),
c) a piston-like end of a hydraulic telescoping cylinder (34) with stops (61),
d) a cable in the tank-car (39),
e) a wench in the tank-car (40),
f) a connector and shut-off valve (41) in the tank-car for the liquid (33),
g) a connector and shut-off valve (42) in the tank-car for the gas (35),
h) a pipe full of liquid (45),
I) a pipe full of gas (46),
j) a track that the tank-cars are attached to (47),
k) a generator (48),
l) a extension cord with floats (49),
m) a valve near the end of the hydraulic telescoping cylinder (60).

4. A process to convert gravity to mechanical energy, comprising:
step 1 is submersing a tank full of liquid,
step 2 is removing the liquid from the submerged tank,
step 3 is attaching the empty tank to a load,
step 4 is floating the empty tank up doing work.
